(19) United States
(12) Patent Application Publication
(10) Pub. No.: US 2010/0192598 A1
(43) Pub. Date: Aug. 5, 2010

(54) DISPENSING LINE COOLING

(75) Inventor: Jan N. Rasmussen, Olstykke (DK)

Correspondence Address: KLEIN, O''NEILL & SINGH, LLP, 18200 VON KARMAN AVENUE, SUITE 725, IRVINE, CA, 92612, US

(73) Assignee: CARLSBERG BREWERIES A/S, Copenhagen V (DK)

(21) Appl. No.: 12/063,514

(22) PCT Filed: Aug. 10, 2006
(86) PCT No.: PCT/DK2006/000436

§ 371 Date: Apr. 6, 2010

(30) Foreign Application Priority Data
Aug. 12, 2005 (DK) 200501146

(51) Int. Cl. F25D 9/00; B67D 7/80; F16L 11/00

(52) U.S. Cl. 62/56; 222/146.6; 138/118

(57) ABSTRACT

A beverage-dispensing assembly having a cooling system includes a dispensing tower having an outer wall defining an inside first channel between a first end and a second end of the tower, wherein a second channel and a third channel are provided in the first channel. The second channel is configured to accommodate a dispensing line, and the third channel is in fluid communication with the second channel at the second end of the tower.

### TECHNICAL FIELD OF THE INVENTION

The present invention relates to an assembly for dispensing beverage comprising a tower and a cooling system. The invention also relates to a method for cooling a dispensing line by use of said assembly for dispensing beverage.

### BACKGROUND OF THE INVENTION

Within the field of dispensing devices, assemblies for dispensing beverages from kegs or other containers and into glasses, e.g. draught beer dispensing assemblies at pubs or bars, are widely known and used. In order to achieve the desired cold temperature of e.g. draught beer, the beer has to be cooled down on the way between the keg and the site of dispensing. This is even the case when the keg is stored at a low temperature, e.g. in a refrigerator, since undesirable warming of the beverage may otherwise take place between the keg and the tap.

One known way to achieve the desired cooling of the beverage is disclosed in EP 1 289 874. A tapping rod with two internal channels is employed, and the tapping line is accommodated within the central channel. Cool air from a refrigerator is then circulated up through the central channel, thus cooling the beverage within the tapping line. The air is re-circulated to the refrigerator via the second channel, which is in fluid communication with the first channel adjacent to the tapping cock at the end of the tapping rod.

A common disadvantage associated with the known techniques is considerable loss of energy to the environment during the cooling of beverage in the tapping rod. Such a loss of energy is both costly and environmentally unacceptable. Another disadvantage is ineffective cooling of beverage during the flow through the tapping line within the tapping rod. The ineffective cooling is especially a problem when the beverage is only transported a short distance in the tapping rod, and therefore only available for cooling for a very short period of time. Inefficient cooling may result in beverage being served at a too high temperature, which may affect both the taste of the beverage and the customer satisfaction in a negative manner.

There is thus a need for a new assembly for dispensing beverage, which can cool down beverage with a minimum of energy waste. There is also a need for an assembly for dispensing beverage, which can cool down beverage flowing in a dispensing line more efficiently.

It is an objective of the present invention to provide a new and inventive assembly for dispensing beverage, which remedy the above-mentioned disadvantages with the prior art. It is specifically an objective to provide an assembly for dispensing beverage, which can cool down beverage in an efficient manner with a minimum loss of energy to the environment.

### SUMMARY OF THE INVENTION

The present invention is new and inventive by providing a tower having an outer wall defining an inside first channel between a first end and a second end of the tower, where at least two channels are arranged in said first channel: a second channel for accommodating a dispensing line, and a third channel which is in fluid communication with said second channel at the second end of the tower. Such a tower is well suited for efficient cooling of a dispensing line and is even suitable for incorporation into existing dispensing assemblies. The tower is especially well suited for keeping an already cool beverage cold during dispensing, such as is the case when dispensing beverage from a refrigerated container.

The term “cooling of the dispensing line” is in the context of present description to be construed as being that the dispensing line is provided with cooling so that the beverage being present in the dispensing line is maintained cold both during dispensing and non-dispensing. It should be understood that the main cooling of the beverage may be performed at a cooling unit, such as a refrigerator.

The second channel may be arranged in the third channel. In this manner the second channel may e.g. be cooled on all sides by cooling medium in the third channel, such as a liquid or a gas.

The first channel may comprise isolation material, such as a gas, foam, or heat reflective material, for isolation of the first channel, the second channel or both. Such isolation may provide for more efficient cooling and less energy loss.

The second channel and the third channel may extend a distance from the first end of the tower to the cooling system and said channels may be isolated along at least part of said distance. This may improve cooling and minimize energy loss, especially in systems with long dispensing lines. The channels may be isolated along the entire distance or only at some parts of the distance.

The cooling system may comprise means for cooling of the dispensing line, such as by gas or liquid cooling.

The cooling system may comprise means for ventilation, such as a mechanical ventilator, for ventilating cool air through at least the second channel. Such ventilation means provide for easy circulation of air.

Cool air may be ventilated through the second channel in a direction opposite to a flow direction of beverage in the dispensing line. Such counter-flow of cool air provides for a very efficient cooling and ensures that the end of the dispensing line near the dispensing tap is well cooled.

The third channel may be omitted and the second channel may be arranged for heat-conduction cooling of the dispensing line. Heat-conduction cooling is a simple and efficient manner of cooling.

The second channel may be arranged in contact with the dispensing line and may be made of a heat-conductive material.

The second channel may comprise a mesh or net of wires of a heat conductive material. Such a mesh or net is a simple and effective manner in which to provide heat-conductive cooling.

The first channel may comprise isolation material, such as a gas, foam, or heat reflective material, for isolation of the second channel. Such isolation provides for more efficient cooling and less loss of energy to the environment.

The dispensing line may be at least partly made of a heat conductive material. This may improve transfer of heat away from the dispensing line and cooling of the beverage inside the dispensing line.

The invention is also new and inventive by providing a tower for use in an assembly for dispensing beverage, said tower comprising an outer wall defining an inside first channel between a first end and a second end of the tower, where at least two channels are arranged in said first channel: a second channel for accommodating a dispensing line, and a third channel which is in fluid communication with said second channel at the second end of the tower.

The present invention is furthermore new and inventive by providing a method for cooling a dispensing line by use of an assembly for dispensing beverage according to any of the preceding claims, said method comprising the steps of introducing a dispensing line in the second channel of a tower, with the beverage flow direction being from the first end of the tower towards the second end of the tower; and circulating cooling medium, such as cool air or liquid, from a cooling system through a first tube in a direction opposite to the beverage flow direction. Such a method is a very simple and user-friendly manner in which to achieve effective cooling of a dispensing line.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows an embodiment of an assembly for dispensing beverage, and

FIG. 2 shows an embodiment of a tower.

All the figures are highly schematic, not necessarily to scale, and they show only parts, which are necessary in order to elucidate the invention, other parts being omitted or merely suggested.

### DETAILED DESCRIPTION OF PREFERRED EMBODIMENTS

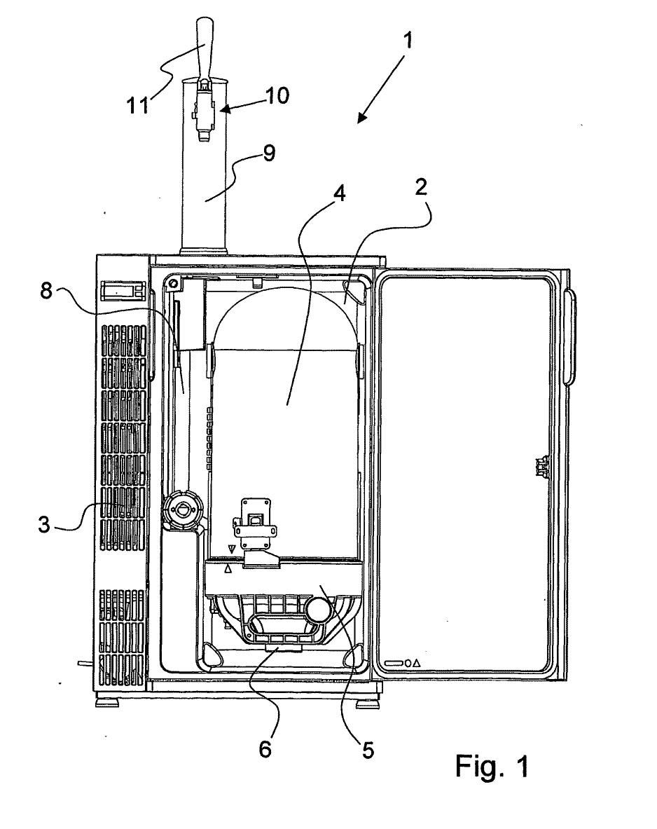

FIG. 1 shows an embodiment of an assembly 1 for dispensing beverage comprising a cooling chamber 2, a cooling system 3, a container (not visible) inside a pressure chamber 4, a pressure chamber lid 5 with an opening 6 for a dispensing line 7 (not shown), a dispensing line channel 8, a tower 9, a dispensing tap 10 and a tap actuator 11. Various materials may be used for the assembly 1 for dispensing beverage. The following are the materials used for a specific embodiment of an assembly 1 for dispensing beverage: the walls and door of the cooling chamber 2 may be made of hard plastic, the container may be made of blended PET, the pressure chamber 4 and its lid 5 may be made of pressure-resistant plastic, the dispensing line channel 8 may be made of hard plastic, the dispensing line may be made of semi-hard plastic, the tower 9 may be made of metal, the dispensing tap and the tap actuator may be made of hard plastic. Many other materials or combinations of materials could be used for the assembly 1 for dispensing beverage.

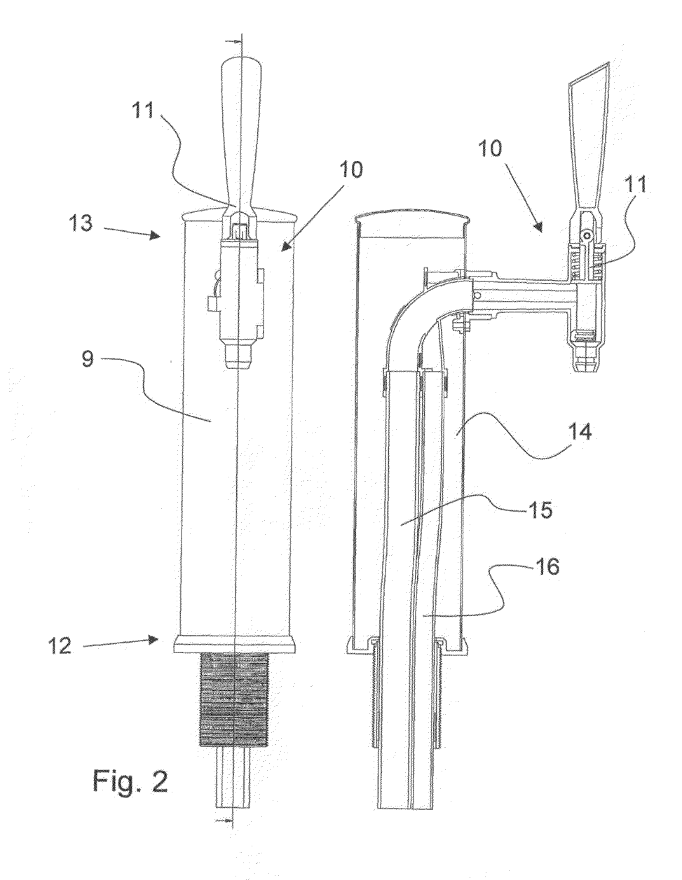

FIG. 2 shows an embodiment of a tower 9 comprising a dispensing tap 10, a tap actuator 11, a first end 12, a second end 13, a first channel 14, a second channel 15, and a third channel 16. The walls of the channels 14-16 may be made of various materials or combinations of materials, such as metal, plastic or rubber. The outer walls of the first channel 14 may be wholly or partially the walls of the tower 9 as illustrated in FIG. 2. The second channel 15 and the third channel 16 are illustrated as extending out of the tower 9 at its first end 12. The second and third channels 15 and 16 are arranged within the first channel 14. The second and third channels 15 and 16 may either, as shown, be juxtaposed, or arranged in some other manner, such as with the second channel 15 arranged wholly or partially inside the third channel 16. The first channel 14 may comprise isolation material for isolating the second and third channels 15 and 16. As a possible side effect of employing isolation in the first channel 14, the outer surface of the tower 9, will no longer be cold compared to the surroundings. Thus, water will not condensate on the surface of the tower 9, and hence the tower 9 will not have the wet and cold-looking appearance known by bar patrons. It may thus, for promotion purposes, be necessary to achieve this appearance of the tower 9 in some other manner.

The tower 9 may be placed directly upon the top of the cooling chamber 2 or optionally at a distance from it, such as on a bar desk. The tower 9 may even be fitted with means for fastening it on a given surface. Any part of the second and third channels 15 and 16 extending between the tower 9 and the cooling chamber 2 may be isolated in order to minimize loss of energy and keep the beverage cool. The fact that the tower 9 can be positioned according to the specific needs and requirements of a user contributes to the flexibility of the assembly 1 for dispensing beverage, and makes it possible and easy to install the assembly 1 for dispensing beverage in even quite restricted spaces.

Various cooling mechanisms may be employed in embodiments of an assembly 1 for dispensing beverage according to the invention. Generally, the cooling system 3 may comprise means for cooling the dispensing line 7. These means may for instance be means for circulating gas or liquid through the second and third channels 15 and 16. In one embodiment (not shown) a ventilator is connected to the cooling system 3. The ventilator may be used for circulating cool air both inside the cooling chamber 2 and through the second and third channels 15 and 16. Since the second channel 15 is in fluid communication with the third channel 16 at the second end 13 of the tower 9, air may be blown into the second channel 15 by the ventilator and the air will then pass over into the third channel 16 and return to the cooling system 3 for re-cooling. Circulation in the opposite direction, namely into the third channel 16 at the cooling system 3 and back through the second channel 15, may be employed to achieve so-called counter-flow cooling. By counter-flow cooling is meant that the cool air is passing along the dispensing line 7 in the opposite direction of the beverage flow in the dispensing line 7. Counter-flow cooling has been shown to enhance the cooling as compared to regular cooling, and has the specific advantage that the cooling is greatest at the end of the dispensing line 7 closest to the dispensing tap 10, thus ensuring that the dispensed beverage has the proper temperature. Counter-flow cooling is especially advantageous in dispensing assemblies 1 with relatively long dispensing lines 7, since the cooling air may otherwise be quite warm at the end of the dispensing line 7 closest to the dispensing tap 10. Counter-flow cooling may even be employed with other cooling mechanisms than air-cooling, such as liquid counter-flow cooling or counter-flow heat-conductive cooling. However, it is within the inventive idea that also parallel-flow cooling, that is letting the cooling medium pass the dispensing line 7 in the same direction as the beverage flow, may be applied.

As indicated, the assembly 1 for dispensing beverage may be adapted for heat-conductive cooling of the dispensing line 7. This may for instance be achieved by constructing the second channel 15 fully or partially of a heat-conductive material, such as copper or other metals. A mesh or net of a heat-conductive material could also be comprised in the second channel 15. The heat-conductive material could be connected to the cooling system 3 for efficient cooling. The second channel 15 could be arranged to closely surround the dispensing line 7, so that good transfer of heat out of the dispensing line 7 and into the heat conductive material could be achieved. When employing heat-conductive cooling in an assembly 1 for dispensing beverage, the third channel 16 may be omitted. Optionally, the dispensing line 7 may comprise a heat-conductive material, either for more efficient transfer of heat out of the dispensing line 7 or for direct heat-conductive cooling of the dispensing line 7.

The tower 9 as well as the method for cooling a dispensing line 7 may possibly be used separately from the assembly 1 for dispensing beverage. For instance, the disclosed tower 9 may well be incorporated into existing dispensing systems and the method of cooling may be practised by making the required inventive modifications to existing dispensing systems.

Although the invention above has been described in connection with preferred embodiments of the invention, it will be evident for a person skilled in the art that several modifications are conceivable without departing from the invention as defined by the following claims.

1. An assembly (1) for dispensing beverage comprising a tower (9) and a cooling system (3), characterized by said tower (9) having an outer wall defining an inside first channel (14) between a first end (12) and a second end (13) of the tower (9), where at least two channels are arranged in said first channel (14): a second channel (15) for accommodating a dispensing line (7), and a third channel (16) which is in fluid communication with said second channel (15) at the second end (13) of the tower (9).

2. An assembly (1) according to claim 1, wherein the second channel (15) is arranged in the third channel (16).

3. An assembly (1) according to any of the preceding claims, wherein the first channel (14) comprises isolation material, such as a gas, foam, or heat reflective material, for isolation of either the second channel (15), the third channel (16) or both.

4. An assembly (1) according to any of the preceding claims, wherein the second channel (15) and the third channel (16) extend a distance from the first end (12) of the tower to the cooling system (3), said channels (15 and 16) being isolated along at least part of said distance.

5. An assembly (1) according to any of the preceding claims, wherein the cooling system (3) comprises means for cooling of the dispensing line (7), such as by gas or liquid cooling.

6. An assembly (1) according to any of the preceding claims, wherein the cooling system (3) comprises means for ventilation, such as a mechanical ventilator, for ventilating cool air through at least the second channel (15).

7. An assembly (1) according to any of the preceding claims, wherein cool air is ventilated through the second channel (15) in a direction opposite to a flow direction of beverage in the dispensing line (7).

8. An assembly (1) according to any of the preceding claims, wherein the third channel (16) is omitted and the second channel (15) is arranged for heat-conduction cooling of the dispensing line (7).

9. An assembly (1) according to claim 8, wherein the second channel (15) is arranged in contact with the dispensing line (7) and is made of a heat-conductive material.

10. An assembly (1) according to any of the claims 8-9, wherein the second channel (15) comprises a mesh or net of wires made of a heat-conductive material.

11. An assembly (1) according to any of the claims 8-10, wherein the first channel (14) comprises isolation material, such as a gas, foam, or heat reflective material, for isolation of the second channel (15).

12. An assembly (1) according to any of the claims 8-11, wherein the dispensing line (7) is at least partly made of a heat conductive material.

13. A tower (9) for use in an assembly (1) according to any one of the previous claims, characterized by said tower (9) comprising an outer wall defining an inside first channel (14) between a first end (12) and a second end (13) of the tower, where at least two channels are arranged in said first channel (14): a second channel (15) for accommodating a dispensing line (7), and a third channel (16) which is in fluid communication with said second channel (15) at the second end (13) of the tower (9).

14. A method for cooling a dispensing line (7) by use of an assembly (1) according to any of the preceding claims, said method comprising the steps of introducing a dispensing line (7) in the second channel (15) of a tower (9), with the beverage flow direction being from the first end (12) of the tower towards the second end (13) of the tower; and circulating cooling medium, such as cool air or liquid, from a cooling system (3) through the second channel (15) in a direction opposite to the beverage flow direction.
